(19) United States
(12) Patent Application Publication
(10) Pub. No.: US 2011/0176577 A1
(43) Pub. Date: Jul. 21, 2011

(54) SUPERPIXEL MULTI-WAVEBAND PHOTODETECTOR ARRAY FOR REMOTE TEMPERATURE MEASUREMENT

(75) Inventors: Sumith V. Bandara, Burke, VA (US); Sarath D. Gunapala, Stevenson Ranch, CA (US); John K. Liu, Pasadena, CA (US); Robert C. Stirbl, Pasadena, CA (US); Daniel W. Wilson, Montrose, CA (US); David Z. Ting, Arcadia, CA (US)

(73) Assignee: California Institute of Technology, Pasadena, CA (US)

(21) Appl. No.: 12/633,714

(22) Filed: Dec. 8, 2009

Related U.S. Application Data
(60) Provisional application No. 61/201,181, filed on Dec. 8, 2008.

(51) Int. Cl. G01J 5/00

(52) U.S. Cl. 374/121

(57) ABSTRACT

A multi-waveband temperature sensor array, in which each superpixel (e.g., 2×2 pixel cell) operates at a distinct thermal infrared (IR) waveband (e.g. four wavebands) is disclosed. Using an example high spatial resolution, four-band thermal IR band photodetector array, accurate temperature measurements on the surface of an object can be made without prior knowledge of the object emissivity. The multiband photodetector may employ intersubband transition in III-V semiconductor-based quantum layered structures where each photodetector stack absorbs photons within the specified wavelength band while allowing the transmission of photons in other spectral bands, thus efficiently permitting multiband detection. This produces multiple, spectrally resolved images of a scene that are recorded simultaneously in a single snapshot of the FPA. From the multispectral images and calibration information about the system, computational algorithms are used to produce the surface temperature map of a target.

### CROSS-REFERENCE TO RELATED APPLICATIONS

This application claims the benefit under 35 U.S.C. §119(e) of the following U.S. provisional patent application, which is incorporated by reference herein:

U.S. Provisional Patent Application No. 61/201,181, filed Dec. 8, 2008, and entitled “2×2 SUPERPIXEL FOUR-BAND PHOTODETECTOR ARRAY SPECIALLY USEFUL FOR REMOTE TEMPERATURE MEASUREMENTS”, by Bandara et al. (Attorney Docket CIT-4772-P3).

### STATEMENT OF GOVERNMENT RIGHTS

The invention described herein was made in the performance of work under a NASA contract, and is subject to the provisions of Public Law 96-517 (35 USC 202) in which the Contractor has elected to retain title.

### BACKGROUND OF THE INVENTION

1. Field of the Invention

This invention relates to infrared photodetectors. Particularly, this invention relates to infrared photodetectors for remote temperature measurement imaging.

2. Description of the Related Art

Current techniques for the collection of surface temperature measurements typically employ either a radiometric process or physical in-situ sensor arrays affixed to the target itself. Traditional radiometric processes are single-band and introduce significant errors in the resulting temperature measurements due to variations in the emissivity of targets. As such, radiometric processes cannot meet the accuracy required for most applications. On the other hand, sensor arrays employing thermometers and thermocouples are intrusive and not acceptable for applications involving moving targets. Additionally, the accuracy of in-situ sensor arrays is highly dependent on physical distance between sensors of the array, contact with the object, and conductivity of the object being irradiated. Typically, there are two approaches for the remote sensing of temperature, imaging radiometers based on single thermal IR band (monochromatic sensors) and the imaging radiometers based on multiple thermal IR bands.

Remote temperature sensing using a single thermal IR band presents some limitations. Traditional radiometric techniques using such monochromatic sensors require prior knowledge of the emissivity of the target in order to measure the temperature accurately. However, this techniques is not always practical as the emissivity may change or be unknown. Accordingly, this presents a significant limitation for monochromatic sensors applied to remote temperature measurement.

Although multi-band IR temperature measurement is far more accurate than its single band counterpart, this approach also has limitations. For example, achieving the required precision alignment for two or more independent thermal IR radiometer cameras is extremely difficult, expensive, and impractical for the typical field environment. Such environments provide only limited space for tracking instrumentation, and require mobilility, whereas, such hybrid systems are typically bulky and have complicated optical trains, which are susceptible to post-fabrication misalignment during operation or transport.

In view of the foregoing, there is a need in the art for apparatuses and methods for improved remote temperature measurement. There is particularly a need for such apparatuses and methods to operate without requiring knowledge of the target emissivity. There is further a need for such apparatuses and methods to operate in robust systems requiring only limited space and alignment precision. These and other needs are met by embodiments of the present invention as detailed hereafter.

### SUMMARY OF THE INVENTION

A multi-waveband temperature sensor focal plane array (FPA), in which each superpixel (e.g., 2×2 pixel cell) operates at a distinct thermal infrared (IR) waveband (e.g. four wavebands) is disclosed. Using an example high spatial resolution, four-band thermal IR band photodetector array, accurate temperature measurements on the surface of an object can be made without prior knowledge of the object emissivity. The multiband photodetector may employ intersubband transition in III-V semiconductor-based quantum layered structures where each photodetector stack absorbs photons within the specified wavelength band while allowing the transmission of photons in other spectral bands, thus efficiently permitting multiband detection. This produces multiple, spectrally resolved images of a scene that are recorded simultaneously in a single snapshot of the FPA. From the multispectral images and calibration information about the system, computational algorithms are used to produce the surface temperature map of a target.

A typical embodiment of the invention comprises a photodetector array including one or more superpixels, each comprising a group of detector subpixels and each of the detector subpixels providing an infrared sensor signal from a target location where each of the group of detector subpixels senses in a distinct infrared wavelength band among the group, and one or more processors for deriving an estimated surface temperature of the target location from a combination of the infrared sensor signal from each of the group of detector subpixels. The estimated surface temperature is derived by calculating a best fit for an equation form for target emissivity over wavelength from the infrared sensor signal from each of the group of detector subpixels combined.

In some embodiments of the invention, the equation form for the target emissivity over wavelength may comprise a general polynomial function. A total number of the group of photodetectors may be one greater than the polynomial constants of the general polynomial function.

In further embodiments of the invention, the group for each of the one or more superpixels comprises four subpixels in a 2×2 pattern. Each of the one or more superpixels may comprise a quantum well infrared photodetector (QWIP). In addition, the photodetector array may comprise a multi-band QWIP focal plane array (FPA) and the one or more superpixels comprise a plurality of superpixels. The multi-band QWIP focal plane array (FPA) may comprise an InGaAs/GaAs/AlGaAs material system. Furthermore, each of the group of subpixels of each of the plurality of superpixels may comprise a multi-quantum well (MQW) stack layered in the InGaAs/GaAs/AlGaAs material system for sensing the distinct infrared wavelength band from the target location.

In some embodiments of the invention, each multi-quantum well (MQW) stack includes an optical grating formed from one or more adjacent layers in the InGaAs/GaAs/AlGaAs material system. However, in further embodiments of the invention, the multi-quantum well (MQW) stack for a pair of the group of subpixels may be directly layered on one another and the distinct wavelength band for each of the pair are filtered for each of the pair of subpixels with different optical gratings.

In a similar manner, a typical method of remote temperature sensing comprises sensing an infrared sensor signal from a target location with one of a group of detector subpixels in a distinct infrared wavelength band among the group of detector subpixels, where one or more superpixels of a photodetector array comprises the group of detector subpixels, and deriving an estimated surface temperature of the target location from a combination of the infrared sensor signal from each of the group of detector subpixels with one or more processors. The estimated surface temperature is derived by calculating a best fit for an equation form for target emissivity over wavelength from the infrared sensor signal from each of the group of detector subpixels combined. The method may be further modified consistent with the apparatus embodiments described herein.

Another apparatus embodiment of the invention may comprise a photodetector means for sensing a group of infrared sensor signals from a target location each in a distinct infrared wavelength band among the group, and a processors means for deriving an estimated surface temperature of the target location from a combination of the group of infrared sensor signals. The estimated surface temperature is derived by calculating a best fit for an equation form for target emissivity over wavelength from the group of infrared sensor signals. The equation form for the target emissivity over wavelength may comprise a general polynomial function and a total number of the group of infrared sensor signals may be one greater than the polynomial constants of the general polynomial function. This apparatus embodiment of the invention may be further modified consistent with other embodiments of the invention described herein.

### BRIEF DESCRIPTION OF THE DRAWINGS

Referring now to the drawings in which like reference numbers represent corresponding parts throughout:

FIG. 1A shows an example plot of spectral exitance of a blackbody source and the spectral response of single band photodetector;

FIG. 1B shows an example plot of estimated signal of MWIR photodetector versus source temperature for different emissivities of a target;

FIG. 2 shows an example plot of spectral responsivity of a four band photodetector and photon exitance of a blackbody at different temperatures;

FIG. 3 shows a schematic view of an array of 2×2 superpixels where each of the four pixels is sensitive to a specific wavelength band;

FIG. 4 shows a schematic device layer diagram of an exemplary four-band QWIP structure for the subpixels of a superpixel in an array;

FIG. 5 shows the measured normalized spectral responsivity curves for each detector of a superpixel of an exemplary device;

FIG. 6 shows an example array of superpixels showing the different gratings of the subpixels;

FIG. 7 is a block diagram of an exemplary system more remote temperature measurement using an array of multiband photodetectors; and

FIG. 8 is a flowchart of an exemplary method of measuring temperature remotely using an array of multiband photodetectors.

### DETAILED DESCRIPTION OF THE PREFERRED EMBODIMENT

1. Overview

Embodiments of the invention may be directed to a novel four-band IR FPA having simultaneously readable co-located QWIPs. In this exemplary FPA, the area of the array may be divided into superpixels comprising 2×2 subpixels for temperature measurement. This system can be used for enhancing the accuracy of temperature measurement on surfaces of unknown emissivity.

2. Remote Temperature Measurement with an Infrared photodetector

The conventional method for the radiometric determination of temperature depends on the measurement of photon flux that an object radiates, in either all wavelengths or some wavelength interval. According to Planck's law, the radiant flux of a blackbody is uniquely defined by the temperature of an ideally emissive blackbody (i.e. an emissivity, ε=1). Therefore, the temperature of the blackbody can be determined using a thermal IR photodetector that remotely measures the radiant flux (φ) within a small wavelength interval Δλ. However, real objects do not strictly exhibit the ideal behavior of a blackbody. Accordingly, applying this simple radiometric measurement of temperature introduces a substantial error due to real emissivity (ε) of the particularly object that varies with surface properties.

The flux measured at the IR photodetector is given by the following equation.

φ_{det}=∫_{Δλ}εM(λ,T)R)(λ)S(λ)dλ (1)

Here, M(λ, T) is the spectral exitance of the source at temperature T, R(λ) is the spectral responsivity of the photodetector, and S(λ) is the optical transfer function of the measurement system. As shown in the equation, the flux received by the photodetector (Φ_{det}) is directly proportional to the emissivity of the source, ε, where 0<ε≦1.

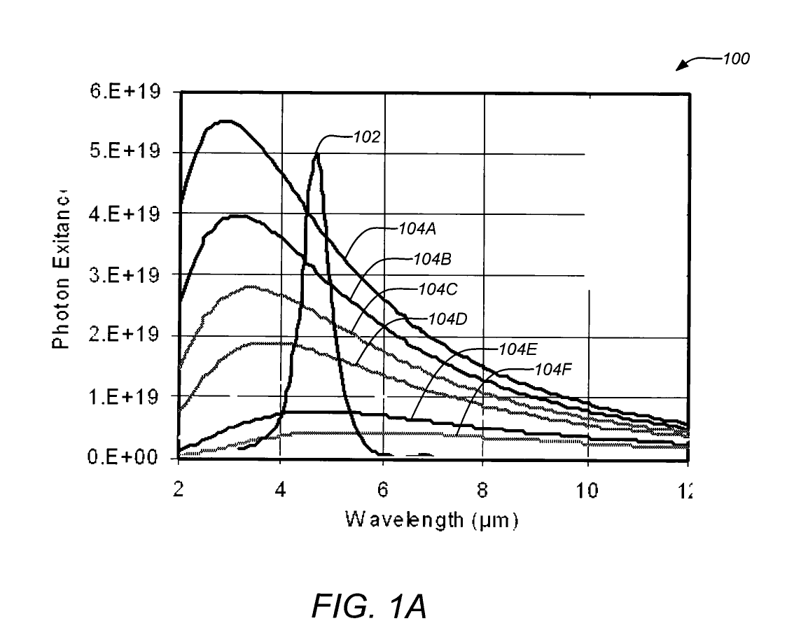

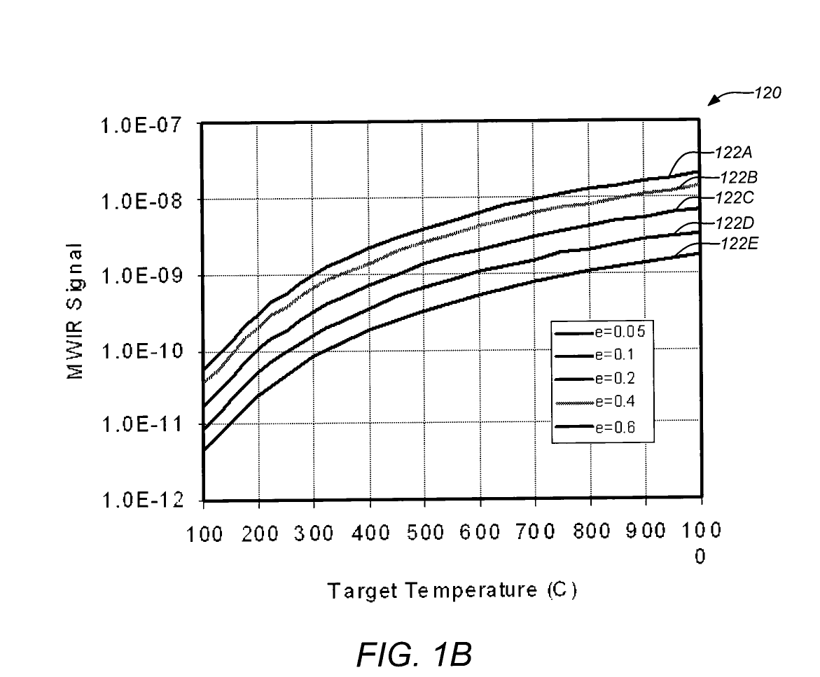

FIG. 1A shows an example plot 100 of spectral exitance of a blackbody source and the spectral response of an example single band mid waveband infrared (MWIR) photodetector. The plot illustrates the variation of an example single band photodetector signal (λ˜4.4 μm-5.1 μm) due to the emissivity of the target as a function of different target temperatures. The photodetector responsivity curve 102 is shown with the photon exitance curves 104A-104F for temperatures, 1000 C, 900 C, 800 C, 700 C, 600 C, 500 C, and 400 C, respectively. FIG. 1B shows an example plot 120 of estimated signal of an example MWIR photodetector versus source temperature for different emissivities of a target. Each estimated signal plot 122A-122E is shown for emissivities of 0.6, 0.4, 0.2, 0.1, and 0.05, respectively. As indicated by the plot 120 given MWIR signal from the photodetector could indicate a very wide range of possible temperatures depending upon the emissivity of the target, particularly at higher temperatures where the curves flatten. Spreading of the curves illustrates the error in estimating source temperature resulting from unknown emissivity. Thus, such a single-band approach can easily lead to errors in estimating the temperature of a target with unknown emissivity.

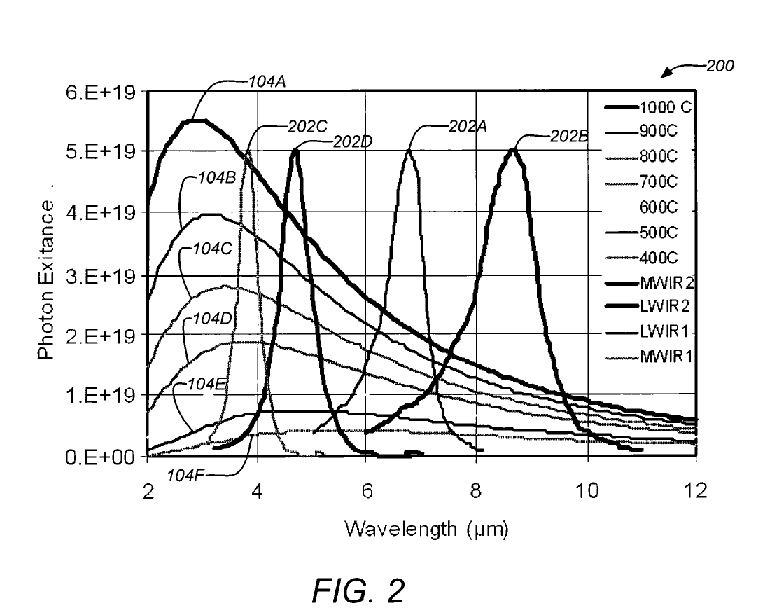

FIG. 2 is an example plot 200 of spectral responsivity of a four band photodetector and photon exitance of a blackbody at different temperatures. The separate photodetectors of the example multi band camera yield separate signals to measure the radiant flux for the separate spectral bands. The critical deficiency of single band photodetector measurement can be overcome by instead using the multiple signals measured at different wavelengths from such a multi-band photodetector. The plot 200 shows four separate photodetector response curves in four separate IR bands, identified as two low waveband response curves 202A, 202B (LWIR1 & LWIR2) and two mid waveband response curves 202C, 202D (MWIR1 & MWIR2). The photon exitance curves 104A-144F are the same as shown in FIG. 1A. Embodiments of the invention can be readily developed by assuming a simple analytical form for spectral emissivity, such as a quadratic polynomial, and calculating the temperature and emissivity of the surface can from the measured signals. In this manner, a more precise determination of temperature can be made by reducing the uncertainty arising from the unknown emissivity of the object. Numerical simulations can show that this technique works particularly well if the shape of the object emissivity is well represented by a N−1 parameter function, where N is the number of spectral bands.

For example, applied to a four waveband infrared photodetector, each photodetector response signal may be described by following function.

$${\int }_{waveband}^{ } ɛ ( λ ) \cdot blackbody ( λ , T ) \cdot R ( λ ) d λ \qquad ( 2 )$$

The spectral responsivity of each photodetector R(λ) is characterized for the particular system for each waveband (e.g. in a calibration). (Note that R(λ) may also include S(λ) the optical transfer function of the measurement system.) The ideal blackbody response is known. This yields a system of equations, one for each photodetector signal, that includes emissivity as a function of wavelength ε(λ). The ε(λ) may be mathematically modeled as a general polynomial function having the following standard form.

ε(λ)=a₀+a₁λ+a₂λ²+ . . . (3)

The best fit for the measured temperature T is then derived for the defined model of ε(λ) (i.e. constants a₀, a₁, a₂, . . . for the defined model). Thus, the system of non-linear equations including variables T, a₀, a₁, a₂ is solved. In general, the measured temperature T may be calculated as long as the total number of the group of photodetectors is one greater than the polynomial constants of the polynomial function. This is because infrared sensor signal from each photodetector sensing in a distinct wavelength band provides a unique equation to the system of equations; one additional unique equation is required to solve for the measured temperature T. Those skilled in the art will appreciate that the inventive principle may be applied to any number of photodetector bands and using any appropriate model equation form for the emissivity as a function of wavelength. In the example, using four separate waveband detectors yields four unique equations which then can be solved for four variables, the measured temperature T and polynomial constants, a₀, a₁, and a₂, for a three term polynomial function. Measurement accuracy may be improved by employing either a greater number of separate waveband photodetectors (which will allow more polynomial terms) or a model equation for specially tuned for emissivity as a function of wavelength or both. It should also be noted that throughout this application the term “distinct infrared wavelength bands” among a plurality of photodetector subpixels indicates that each subpixel of a defined group (e.g. of a single superpixel) detects infrared radiation in a band different from the other subpixels of the group. The distinct infrared wavelength bands are sufficiently differentiated such that analytical derivation of a surface temperature estimate for a location on the target may be achieved.

3. MultiBand Infrared Photodetector for Remote Temperature Measurement

Embodiments of the present invention may implement the described multi-band algorithm through the use of a stable, pixel co-located, and simultaneously readable photodetector array operating at four distinct thermal IR wavelengths. A multi-band quantum well infrared photodetector (QWIP) may be applied to yield multiband IR imaging for remote temperature measurement. Specifically, by leveraging an existing megapixel co-located monolithic dual band QWIP camera and of four-band QWIP array, embodiments of the invention can apply Planck's equation to achieve practical remote temperature measurement without prior knowledge of the emissivity of the measured object. See Gunapala et al., Infrared Physics & Technology 44 (2003) 369-375, which is incorporated by reference herein.

For example, an applicable multi-band quantum well infrared photodetector (QWIP) array has been described in U.S. Pat. No. 6,580,089, issued Jun. 17, 2003, to Bandara et al., which is incorporated by reference herein. The exemplary device comprises a substrate formed of a semiconductor, a common contact layer formed on said substrate, a first sensing region formed over said common contact layer and having a plurality of adjacent first sensing pixels responsive to radiation at a first spectral band, a second sensing region formed over said common contact layer and spatially separated from said first sensing region, said second sensing region having a plurality of adjacent second sensing pixels responsive to radiation at a second spectral band. Each of said first and said second sensing pixels has a plurality of multiple-quantum-well (MQW) structures respectively responsive to different spectral bands formed over said common contact layer in a stack, and a plurality of contact layers to sandwich each MQW structure in combination with said common contact layer, wherein, in said first sensing region. A MQW structure responsive to said first spectral band is electrically biased to be active and other MQW structures are electrically shorted to be inactive. In said second sensing region, a MQW structure responsive to said second spectral band is electrically biased to be active and other MQW structures are electrically shorted to be inactive.

Recently, a particular 640×512 format four-band QWIP focal plane array (FPA) based on an InGaAs/GaAs/AlGaAs material system has been developed. Those skilled in the art will appreciate that such QWIP focal plane arrays may be similarly developed for the InGaAs/InAlAs/InP material system and applied in embodiments of the present invention as well. The general parameters of the structure and design have been previously described in U.S. Pat. No. 6,580,089. This example FPA comprises four independently readable IR bands covering 4-5.5 μm, 8.5-10 μm, 10-12 μm, and 13-15.5 μm and each band occupies a 320×256 pixel area dispersed across the overall imaging array (i.e., one quarter of the subpixels).

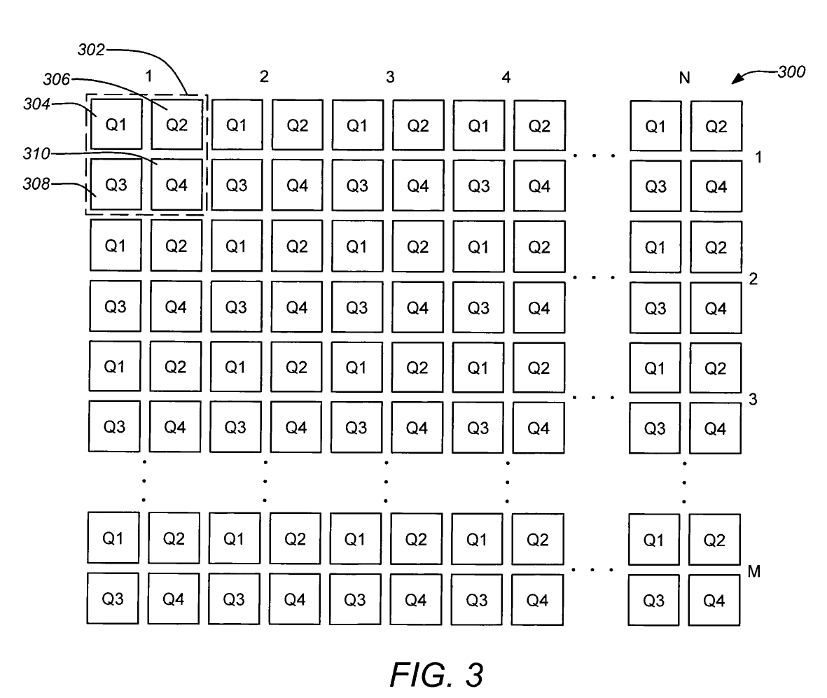

FIG. 3 is a schematic view of an exemplary array 300 of 2×2 superpixels where each of the four subpixels of each superpixel is sensitive to a specific wavelength band. Embodiments of the present invention apply the novel technique for realization of a four band infrared imaging FPA described above with such colocated pixels which may be adapted from the architecture of a known QWIP FPA design. In this present FPA however, the area of the array 300 is divided into 2×2 subpixel areas that each function as a superpixel 302 for remote temperature measurement. Each QWIP subpixel 304, 306, 308, 310 of each superpixel 302, identified as Q1, Q2, Q3 and Q4 in FIG. 3, is sensitive to one of four specific wavelength bands. The apparent blackbody temperature of the measured object in each spectral band can be determined using a multipoint calibration curve from the received signal from each subpixel, Q1, Q2, Q3 and Q4. Following this, the actual surface temperature can be calculated from these four apparent temperatures and a proposed functional form of the spectral emissivity curve applying the technique described in the previous section. This can be done for each of the N×M superpixels to determine the temperature for each point of the imaging array 300 corresponding to different points of the target object.

The GaAs/AlGaAs-based QWIP is an excellent candidate for the development of such multi-band FPAs due to its inherent properties, such as narrow band response and wavelength tailorability. See Levine, J. Appl. Phys. 74 (1993) R1; Gunapala et al., “Physics of Thin Films,” vol. 21, Academic Press, New York, 1995, pp. 113-237; and Gunapala et al., “Quantum Well Infrared Photodetector (QWIP) Focal Plane Arrays,” Semiconductors and Semimetals, vol. 62, Academic Press, New York, 1999, pp. 197-282, which are all incorporated by reference herein. The GaAs/AlGaAs-based QWIP architecture also permits vertical integration of multi-quantum well (MQW) stacks. See Gunapala et al., IEEE Trans. Electron. Dev. 47 (2000) 963-971; Bandara et al., SPIE 4454 (2001) 30; and Bandara et al., “Array of QWIPs with spatial separation of multiple colors,” NASA Tech Briefs 26 (5) (2002) 8a, which are all incorporated by reference herein.

Each MQW stack absorbs photons within the specified wavelength band allowing other photons to pass through. The wavelength of the peak response and cutoff can be continuously tailored by varying layer thickness (well width), barrier composition (barrier height), and carrier density (well doping density). The GaAs/AlₓGa₁_{_{—}}ₓAs material system allows the quantum well parameters to be varied over a range wide enough to enable light detection at any wavelength range between 6 and 20 μm. See Gunapala et al., J. Appl. Phys. 69 (1991) 6517; and Choi, J. Appl. Phys. 73 (1993) 5230, which are both incorporated by reference herein. In addition, by adding a few monolayers of In_{y}Ga_{1-y}As during the GaAs quantum well growth, the short wavelength limit can be further extended to 3 μm. See Choi et al., J. Appl. Phys. 91 (2002) 5230, which is incorporated by reference herein. The spectral bandwidth of each subpixel of the array photodetectors can be tuned from narrow (Δλ/λ˜10%) to wide (Δλ/λ˜40%), according to application requirements. See Bandara et al., “10-16 μm broadband quantum well infrared photodetector,” Appl. Phys. Lett. 72 (1998) 2427, which is incorporated by reference herein.

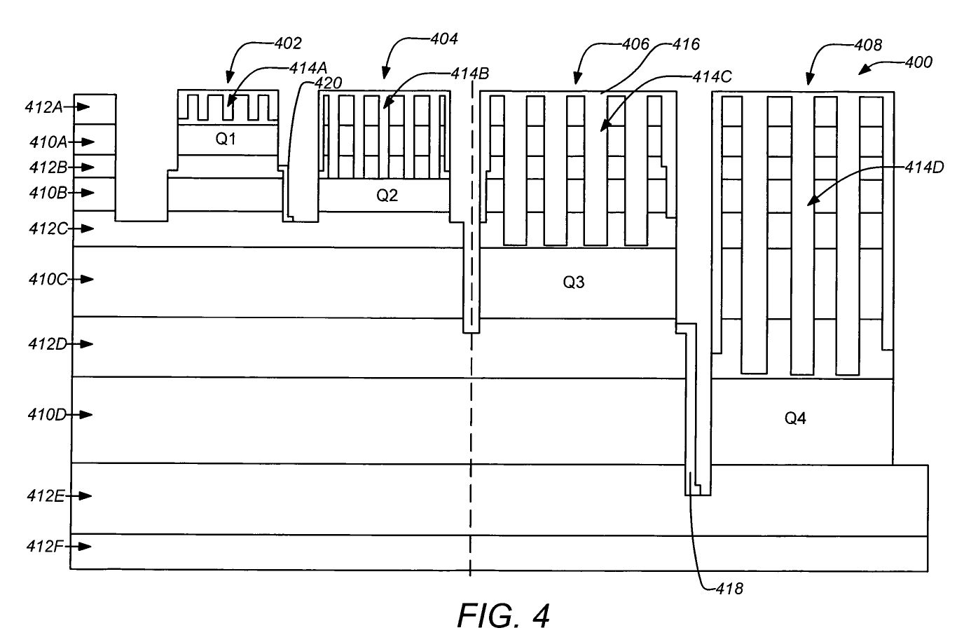

FIG. 4 shows a schematic device layer diagram of an exemplary four-band QWIP stack structure 400 for the subpixels of a superpixel in an array. Note that the layer diagram of FIG. 4 shows each of the subpixels, Q1 402, Q2 404, Q3 406 and Q4 408 linearly from left to right to illustrate the contiguous layers of the stack structure 400. However, a typical superpixel will be a 2×2 pattern as shown in FIG. 3. The stack structure 400 of each separate subpixel Q1 402, Q2 404, Q3 406 and Q4 408 is the same regardless of the planar arrangement of the subpixels in the array. The dashed line between the Q2 and Q3 subpixels in FIG. 4 indicates the non-linear physical configuration for the subpixels Q1 402, Q2 404, Q3 406 and Q4 408. Note that in use, the finished structure 400 receives incident light through the bottom layers, e.g. contact layer 412E. The individual signals from the subpixels Q1 402, Q2 404, Q3 406 and Q4 408 are coupled out through separate contacts, e.g. indium bumps, on the top surfaces of each of the gold coated gratings 414A-414D (The bottom substrate layer 412F is typically only used during manufacturing for handling and then removed.)

A typical QWIP for the array 300 may comprise a 50-period MQW structure of GaAs quantum wells, separated by AlₓGa₁_{_{—}}ₓAs barriers, sandwiched between two GaAs contact layers. Both GaAs contact layers and GaAs quantum well layers may be doped with Si (n-type) in order to provide carriers for photoexcitation. The example stack structure 400 includes four QWIP stacks Q1 410A, Q2 410B, Q3 410C, and Q4 410D, separated by intra-stack contact layers 412B-412D. All four stacks are then sandwiched between two outermost contact layers 412A, 412E. The four-band QWIP stack structure 400 is designed to provide one functional QWIP stack Q1 410A, Q2 410B, Q3 410C, and Q4 410D for each of the subpixels, Q1 402, Q2 404, Q3 406 and Q4 408, respectively. Accordingly, the subpixels Q1 402, Q2 404, Q3 406 and Q4 408 may also be identified by the applicable quantum well Q1-Q4.

The thickness of each QWIP stack 410A-410D may be determined by the width of the quantum well, width of the barrier, number of periods in the particular MQW and the contact layer thickness. Usually, these thicknesses, together with quantum well doping densities, are determined to optimize device performance without any external constraints. However, in the present four-band structure 400, the required groove depths of the light coupling gratings 414A-414D can influence the selected thicknesses of the top three QWIP stacks Q1 410A, Q2 410B, Q3 410C.

In order to be absorbed by the confined carriers in the quantum well stacks Q1 410A, Q2 410B, Q3 410C, and Q4 410D, the light polarization must have an electric field component normal to the layers of quantum wells (i.e., along the growth direction). Thus, for imaging, it is necessary to fabricate a light-coupling gratings 414A-414D on top of each photodetector subpixel, which reflects light along the layer plane, enabling absorption. (Each of the gratings 414A-414D may be formed with gold coatings as known in the art.) For efficient coupling to the relevant absorbing QW stack Q1 410A, Q2 410B, Q3 410C, and Q4 410D of each subpixel, the grating should perform two important functions: (1) diffract efficiently into high angles and (2) have a near-zero diffraction efficiency at low angles. The first condition can be produced by a grating that has significant depth variation on the scale of one wavelength. The second condition can be produced by a grating that produces destructive interference of all reflected waves in the direction normal to the surface. This can be expressed by the following equation.

$$h = m \frac{{λ}_{p}}{4 {n}_{GaAs}} , m : 1 , 3 , 5 , … , \qquad ( 4 )$$

In equation (4), h is the grating grove depth, λₚ is the peak response wavelength of QWIP stack, and n_{GaAs} is the refractive index of GaAs. See Sarusi et al., J. Appl. Phys. 76 (1994) 4989, which is incorporated by reference herein.

In the example structure 400, total thickness of the top three QWIP Q1 410A, Q2 410B, Q3 410C stacks (and contact layers 412A-412D) may be ideally approximately equal to the groove depth of the grating 414D of the fourth photodetector subpixel Q4 408 as shown. The total thickness of the top two QWIP stacks Q1 410A, Q2 410B (and contact layers 412A-412C) is approximately equal to the groove depth of the grating 414C of the third photodetector subpixel Q3 406. Finally, the total thickness of the top QWIP stack Q1 410A (and contact layers 412A, 412B) is approximately equal to the groove depth of the grating 414B of the second photodetector subpixel Q2 404. These thickness constraints are important to the objective of achieving a nearly flat top surface across the photodetector array gratings because the grating surfaces are used to provide the separate electrical contacts for the subpixels. Applying contacts to the subpixels at a common height is ideal. For example, a substantially flat surface across the gratings can dramatically aid coupling to a readout multiplexer via indium bump-bonding.

In a single wavelength band QWIP FPA, quarter wavelength deep (h=λₚ/4n_{GaAs}) grating grooves are typically used to fulfill grating equation (4) above. However, in the example stack structure 400, the thickness of the quarter wavelength deep grating grooves is not ideal, as discussed above, because several QWIP stacks may need to be included as part of the groove depth for the gratings (e.g., three QWIP stacks Q1 410A, Q2 410B, Q3 410C of 9-10 μm for the grating 414D in FIG. 4). Therefore, in this application, three-quarter wavelength groove depths (h=3λₚ/4n_{GaA}) may be used. This technique allows optimization of the light coupling of each QWIP stack at corresponding subpixels while keeping the subpixel (or mesa) height at the same level as the others. This can be important to create a highly uniform hybrid with a detector array bonded to a multiplexer via indium bumps as discussed above. It should be noted that although an array where all subpixels have a common mesa height is ideal, most practical designs will result in some difference in the heights of the subpixels. Nevertheless, deeper gratings, e.g. three-quarter wavelength groove depths, can help aid integration for the reasons previously discussed.

Typically in QWIPs, the dark current for the device is dominated by the thermal excitation across the sub-band gap, which sets the operating temperature. The Q4 QWIP device structure may be optimized to minimize the dark current. This dark current is the highest among the Q4 subpixel detector due to its smallest sub-band gap being associated with the longest wavelength response. Due to thickness restrictions set by the optical gratings, a lower number of periods and thinner barriers may be utilized in the Q1, Q2 and Q3 subpixel detectors. In order to balance the lowered absorption quantum efficiency associated with fewer periods, quantum wells may be doped to a higher carrier density. This is typically not the preferred way to improve the QWIP performance, because higher carrier density increases the thermal excitation (i.e. dark current of the detector). However, in the described four wavelength band detector this not a problem for the top three subpixel detectors, Q1, Q2, and Q3, because of the lower operating temperature set by the longest wavelength subpixel detector Q4.

An exemplary device structure may comprise a 0.3 λm thick stack of 8 period MQW structure (Q1), a 0.4 μm thick stack of 8 period MQW structure (Q2), a 1.1 λm thick stack of 20 period MQW structure (Q3), and a 1.2 λm thick stack of 20 period MQW structure (Q4). The quantum well parameters of Q1, Q2, Q3, and Q4 can be readily designed to respond at 3.5-4.5 μm, 4.5-5.5 μm, 7.5-8.5 μm, and 9-10 μm wavelength ranges, respectively. Each photosensitive MQW stack may be separated by a heavily doped intermediate GaAs contact layer, with a thickness ranging from 0.4 to 0.8 μm. See FIG. 4. The quantum wells in the Q1, Q2, Q3 and Q4 structures may be doped with Si up to a carrier density of n=3×10¹⁸ cm³, n=2×10¹⁸ cm³, n=5×10¹⁷ cm³, and n=5×10¹⁷ cm³, respectively. This example four-band QWIP device structure may then be sandwiched between 0.4 and 1 μm GaAs top and bottom contact layers doped with n=1×10¹⁸ cm³ and n=5×10¹⁷ cm³. Those skilled in the art will appreciate that other detailed designs for MQW structures of superpixels comprising multiple subpixels may be developed employing the principles described herein. The number superpixels and associated subpixels as well as the sizes, gratings and wavelength bands may be varied.

In some embodiments, the complexity associated with the fabrication of the four waveband superpixel can be substantially reduced. Instead of having each of the four types of subpixels associated with separate quantum well stacks Q1, Q2, Q3 and Q4, each with its own distinct top contact and bottom contact layer (as shown in FIG. 4), a simplified architecture may be employed. Quantum well stacks Q1 and Q2 may be combined together such that they share a common top contact layer and a common bottom contact layer and eliminate any contact layer between them. A similar scheme may be applied to quantum well stacks Q3 and Q4. Thus, each pair of the group of subpixels employs quantum wells directly layered on one another. The distinct wavelength band for each of the pair of subpixels is then filtered with different optical gratings so that the distinct wavelength bands are properly directed to each subpixel of the pair. With the combined Q1-Q2 pair, one subpixel includes a grating substantially favoring the absorption by Q1, the other with a different grating substantially favoring the absorption by Q2. Similarly, the combined Q3-Q4 pair may be divided into two types of subpixels by different optical gratings. The end result is again a 2×2 superpixel with four subpixels of distinct wavelength band absorption characteristics, but now with only two distinct mesa heights instead of four. The simplified structure is similar to the structure 400 shown in FIG. 4, except that contact layers 412B and 412D between QWIP stacks Q1 410A and Q2 410B and between QWIP stacks Q3 410C and Q4 410D are eliminated. Eliminating contact layers in the structure substantially reduces the device manufacturing processing requirements. In addition, selection of the combined pairs of QWIP stacks can make separation of the distinct wavelength bands easier with the gratings. For example, the Q1-Q2 pair may include quantum wells delivering the shortest and the third shortest wavelength bands (instead of the shortest and the second shortest wavelength bands). This will better facilitate wavelength band separation between Q1 and Q2 subpixels using optical gratings because the two wavelength bands of interest are more separated from one another.

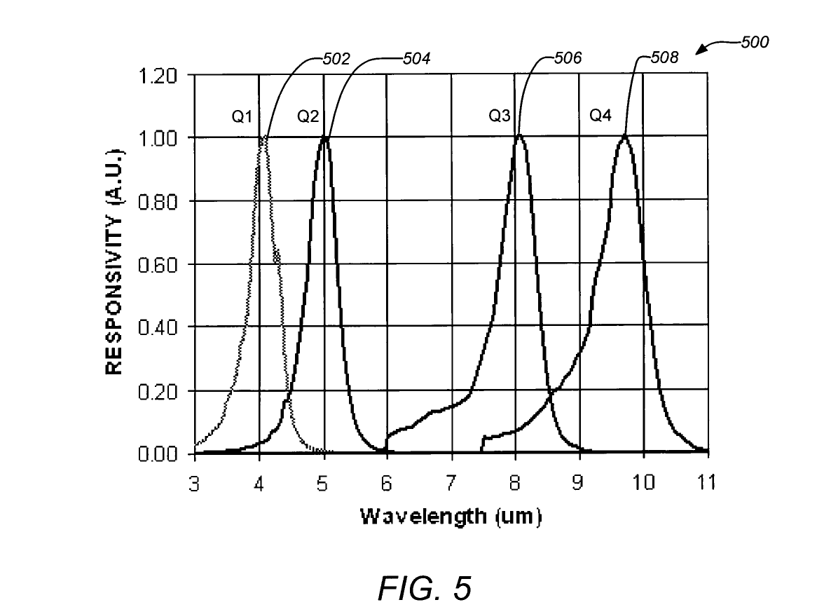

FIG. 5 is a plot 500 of example measured normalized spectral responsivity curves 502, 504, 506, 508 for each subpixel detector of a superpixel of an exemplary device. Each normalized spectral responsivity curve 502, 504, 506, 508 corresponds to a Q1, Q2, Q3, and Q4 subpixel, respectively, in the array 300 employing the stack structure 400 described in FIGS. 3 and 4. The example structure may be grown by molecular beam epitaxy on a 4-inch semi-insulating GaAs substrate wafer. In order to characterize the device, large test stacks, e.g., 200-400 μm in diameter, may be fabricated using wet chemical etching and evaporation of Au/Ge ohmic contacts on the top and bottom contact layers. The responsivity spectra of these detectors may be measured using a 1000 K blackbody source and a grating monochromator. The detectors may be back illuminated through a 45° polished facet to obtain normalized responsivity curves at different bias voltages. Then the absolute spectral responsivities may be obtained by measuring the total photocurrent under exposure to a calibrated blackbody source.

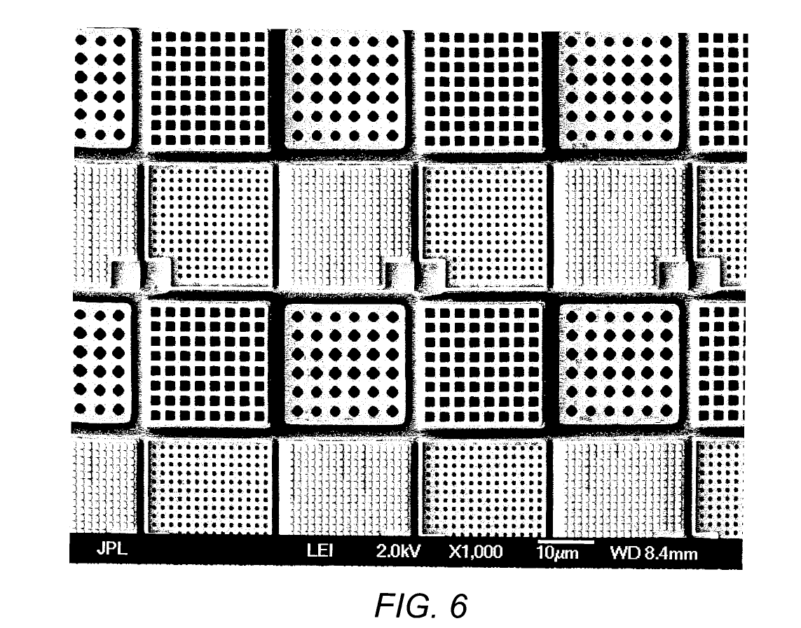

FIG. 6 is a scanning electron microscope image showing an example array of superpixels showing the different gratings of the subpixels. During the fabrication of the example detector array, the grooves of two dimensional gratings on top of the subpixels may be defined first by optical photolithography and dry etching for each desired infrared band. Next, the individual subpixels may be fabricated by known photolithographic processing techniques. For each subpixel, its separate waveband may be defined by a deep trench etch process coupled with short-circuiting the unwanted quantum well layers. Gold coated gratings can be used to short unwanted quantum well layers above, while an etched via or step-like via hole filled with metal may be used to short unwanted quantum well layers below. For example, in the example structure 400 of FIG. 4, the unwanted quantum well layer Q2 in the subpixel Q1 402 is shorted by etching a step-like via hole and then installing a metal strip 420. Subpixel Q3 406 is similarly shorted below with metal strip 418. The example array of FIG. 6 shows a step-like via hole at the common corner of the top two detector subpixels Q1 and Q2. All the other subpixels using lower quantum well layers Q2-Q4 may be electrically shorted through the column or rows at the outside edge of the array. The fabricated array can be hybridized to CMOS multiplexers and then mounted into an 84-pin lead-less chip carrier. Performance of the finished detector array may then be characterized in a laboratory dewar.

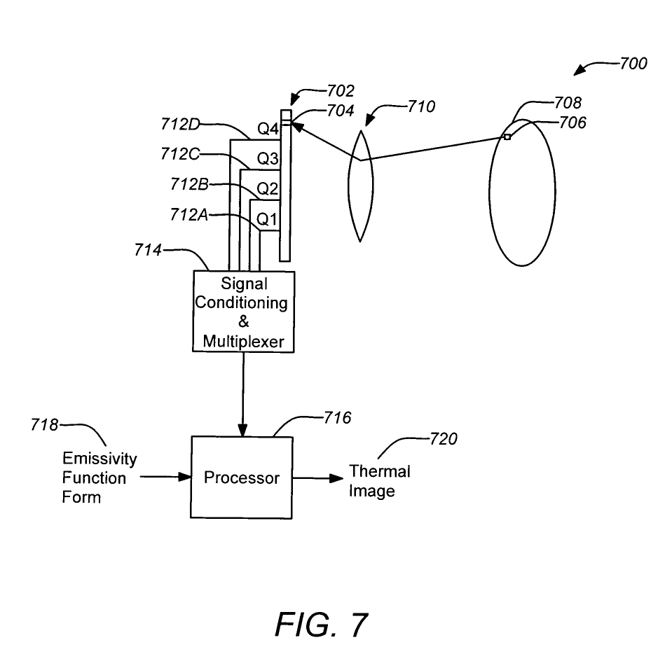

FIG. 7 is a block diagram of an exemplary system 700 for remote temperature measurement using an imaging array 702 of multiband infrared photodetectors. The infrared photodetector imaging array 702 includes a plurality of superpixels 704 (e.g. in a 320×256 array) each comprising four subpixels (e.g. corresponding to 640×512 subpixels). Importantly, each subpixel is sensitive to a distinct infrared wavelength band among the subpixels for a given superpixel 704. Accordingly, each the subpixels for each superpixel 704 provide a separate infrared sensor signal 706A-706D. (Note that only the four infrared sensor signals 706A-706D from a single superpixel 704 in order to illustrate operation of the system.) The imaging array 702 may be produced as previously described. Each superpixel 704 receives infrared radiation from a location 706 on the target 708. Infrared radiation from the target may be directed and focused onto the array 702 through appropriate optics 710. The appropriate optics 710 will be determined based upon the specifications of the array 702 and the specific application as will be understood by those skilled in the art.

The separate infrared sensor signals 706A-706D from each subpixel of each superpixel 704 of the array 702 may be coupled out of the array 702 a signal multiplexer 714 (i.e. read out integrated circuit [ROIC] which may also include any appropriate signal conditioning and processing) as will be understood by those skilled in the art. One or more processors 716 receive the information of infrared sensor signals 706A-706D and derive an estimated surface temperature for the location 706 on the target 708 corresponding to the superpixel 704 by calculating a best fit for an equation form for target emissivity 718 under the analysis previously described. The one or more processors 716 may be any suitable programmable or dedicated computing device as will be understood by those skilled in the art. A complete thermal image 720 of the target 708 is produced as the combined surface temperature estimates for all the superpixels of the array 702 corresponding to every viewable point on target 708.

4. Method of Remote Temperature Measurement

Embodiments of the invention also encompass a method of remote temperature measurement with a multi-band quantum well infrared photodetector (QWIP).

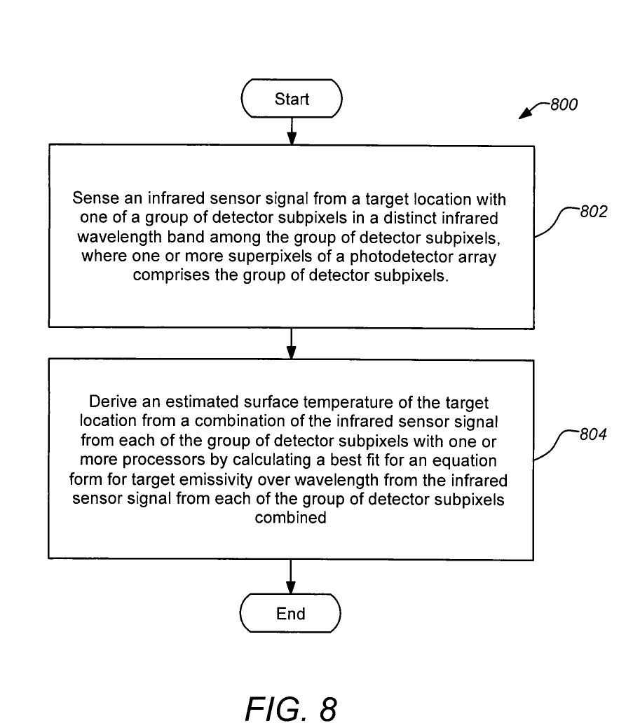

FIG. 8 is a flowchart of an exemplary method of measuring temperature remotely using an array of multiband photodetectors. The method 800 begins with an operation 802 of sensing an infrared sensor signal from a target location with one of a group of detector subpixels in a distinct infrared wavelength band among the group of detector subpixels, where one or more superpixels of a photodetector array comprises the group of detector subpixels. Next, in operation 804, an estimated surface temperature of the target location is derived from a combination of the infrared sensor signal from each of the group of detector subpixels with one or more processors. The estimated surface temperature is derived by calculating a best fit for an equation form for target emissivity over wavelength from the infrared sensor signal from each of the group of detector subpixels combined. Typically, the equation form for the target emissivity over wavelength may comprise a general polynomial function and a total number of the group of photodetectors is one greater than the polynomial constants of the general polynomial function.

The method 800 may be further enhanced through optional operations consistent with the described parameters and any known techniques of optical semiconductor device manufacture and signal processing as will be understood by those skilled in the art. In addition, note that the order of operations may be altered consistent with known techniques for semiconductor device manufacture and operation.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. An apparatus, comprising:
a photodetector array including one or more superpixels, each comprising a group of detector subpixels and each of the detector subpixels providing an infrared sensor signal from a target location where each of the group of detector subpixels senses in a distinct infrared wavelength band among the group; and
one or more processors for deriving an estimated surface temperature of the target location from a combination of the infrared sensor signal from each of the group of detector subpixels;
wherein the estimated surface temperature is derived by calculating a best fit for an equation form for target emissivity over wavelength from the infrared sensor signal from each of the group of detector subpixels combined.

2. The apparatus of claim 1, wherein the equation form for the target emissivity over wavelength comprises a general polynomial function.

3. The apparatus of claim 2, wherein a total number of the group of photodetectors is one greater than the polynomial constants of the general polynomial function.

4. The apparatus of claim 1, wherein the group for each of the one or more superpixels comprises four subpixels in a 2×2 pattern.

5. The apparatus of claim 1, wherein each of the one or more superpixels comprises a quantum well infrared photodetector (QWIP).

6. The apparatus of claim 5, wherein the photodetector array comprises a multi-band QWIP focal plane array (FPA) and the one or more superpixels comprise a plurality of superpixels.

7. The apparatus of claim 6, wherein the multi-band QWIP focal plane array (FPA) comprises an InGaAs/GaAs/AlGaAs material system.

8. The apparatus of claim 7, wherein each of the group of subpixels of each of the plurality of superpixels comprises a multi-quantum well (MQW) stack layered in the InGaAs/GaAs/AlGaAs material system for sensing the distinct infrared wavelength band from the target location.

9. The apparatus of claim 8, wherein each multi-quantum well (MQW) stack includes an optical grating formed from one or more adjacent layers in the InGaAs/GaAs/AlGaAs material system.

10. The apparatus of claim 8, wherein the multi-quantum well (MQW) stack for a pair of the group of subpixels are directly layered on one another and the distinct wavelength band for each of the pair are filtered for each of the pair of subpixels with different optical gratings.

11. A method of remote temperature sensing, comprising:
sensing an infrared sensor signal from a target location with one of a group of detector subpixels in a distinct infrared wavelength band among the group of detector subpixels, where one or more superpixels of a photodetector array comprises the group of detector subpixels; and
deriving an estimated surface temperature of the target location from a combination of the infrared sensor signal from each of the group of detector subpixels with one or more processors by calculating a best fit for an equation form for target emissivity over wavelength from the infrared sensor signal from each of the group of detector subpixels combined.

12. The method of claim 11, wherein the equation form for the target emissivity over wavelength comprises a general polynomial function.

13. The method of claim 12, wherein a total number of the group of photodetectors is one greater than the polynomial constants of the general polynomial function.

14. The method of claim 11, wherein the group for each of the one or more superpixels comprises four subpixels in a 2×2 pattern.

15. The method of claim 11, wherein each of the one or more superpixels comprises a quantum well infrared photodetector (QWIP).

16. The method of claim 15, wherein the photodetector array comprises a multi-band QWIP focal plane array (FPA) and the one or more superpixels comprise a plurality of superpixels.

17. The method of claim 16, wherein the multi-band QWIP focal plane array (FPA) comprises an InGaAs/GaAs/AlGaAs material system.

18. The method of claim 17, wherein each of the group of subpixels of each of the plurality of superpixels comprises a multi-quantum well (MQW) stack layered in the InGaAs/GaAs/AlGaAs material system for sensing the distinct infrared wavelength band from the target location.

19. The method of claim 18, wherein each multi-quantum well (MQW) stack includes an optical grating formed from one or more adjacent layers in the InGaAs/GaAs/AlGaAs material system.

20. The method of claim 18, wherein the multi-quantum well (MQW) stack for a pair of the group of subpixels are directly layered on one another and the distinct wavelength band for each of the pair are filtered for each of the pair of subpixels with different optical gratings.

21. An apparatus, comprising:
a photodetector means for sensing a group of infrared sensor signals from a target location each in a distinct infrared wavelength band among the group; and
a processors means for deriving an estimated surface temperature of the target location from a combination of the group of infrared sensor signals;
wherein the estimated surface temperature is derived by calculating a best fit for an equation form for target emissivity over wavelength from the group of infrared sensor signals.

22. The apparatus of claim 21, wherein the equation form for the target emissivity over wavelength comprises a general polynomial function.

23. The apparatus of claim 22, wherein a total number of the group of infrared sensor signals is one greater than the polynomial constants of the general polynomial function.
